(19) United States
(12) Patent Application Publication
(10) Pub. No.: US 2004/0075976 A1
(43) Pub. Date: Apr. 22, 2004

(54) Latch device and electronic apparatus with latch device

(76) Inventor: Ming-Chang Lee, Taipei (TW)

Correspondence Address: SHAW PITTMAN LLP, 1650 TYSONS BOULEVARD, MCLEAN, VA, 22102, US

(21) Appl. No.: 10/615,994

(22) Filed: Jul. 10, 2003

(30) Foreign Application Priority Data
Oct. 22, 2002 (TW) 91216868

(51) Int. Cl. G06F 1/16

(52) U.S. Cl. 361/683

(57) ABSTRACT

The invention relates to a latch device for engaging with a keyboard within a housing of a portable electronic apparatus. The latch device includes a support, a latch, and a saw-toothed elastic strip. The support is connected with the housing, and a portion of the latch stretches out from the housing to engage with the keyboard. Two ends of the first saw-toothed elastic strip connect respectively with the support and the latch. The latch moves relatively toward the support by using the first saw-toothed elastic strip. The keyboard can be detached from the housing when an external force presses the latch into the housing. Moreover, because of the deformation of the first saw-toothed elastic strip, the first saw-toothed elastic strip provides a recovering force to press a portion of the latch out of the housing.

### CROSS REFERENCE TO RELATED APPLICATIONS

This Application claims priority to Taiwan Patent Application No. 091216868 entitled “Latch Device and Electrical Apparatus with Latch Device,” filed Dec. 20, 2002.

### FIELD OF THE INVENTION

The present invention relates to a latch device for engaging a predetermined device with the housing of a portable electronic apparatus, and more particularly, to a latch device for engaging a keyboard with the housing of a portable electronic apparatus.

### BACKGROUND OF THE INVENTION

A portable electronic apparatus often has to integrate multiple electronic devices, such as an input device, into its body to satisfy the needs of users. However, the integrated devices may influence the portability of the electronic apparatus. Therefore, there exists a need to minimize the volume of the electronic apparatus.

For example, a keyboard has to be installed within the housing of a laptop for users to input data. Since keyboards are in the shape of a plate, it is usually disposed on the top surface of the laptop housing, while other components are disposed under the keyboard to reduce the volume of a laptop. Meanwhile, the keyboard is usually designed to be detached from the housing so that the components under the keyboard can be replaced more easily.

In prior art, the keyboard engages with the housing by a latch which is within the housing and extends a part of it out of the housing. When users want to detach the keyboard from the housing, they have to press the latch into the housing so that the keyboard would disengage from the housing. The latch connects to a spring connecting to the housing. When the latch is pressed into the housing, the latch forces the spring to compress. When the force disappears, the spring makes a part of the latch spring out of the housing.

However, the aforementioned latch and its related components often occupy larger space, which might be disadvantageous to a laptop. Besides, since a conventional latch comprises of more components, the assembly of a laptop would get more difficult and take more time.

### SUMMARY OF THE INVENTION

The main aspect of the present invention provides a latch device for use with a portable electronic apparatus, and the latch device engages a predetermined device with the housing of the electronic apparatus.

Another aspect of the present invention provides a latch device that can reduce the time and cost of assembly.

The present invention also provides a latch device to save the assembling time and reduce the cost.

The latch device includes a support, a latch, and a first saw-toothed elastic strip. The support connects to the housing and the latch connects to the keyboard. With one end of the first saw-toothed elastic strip connecting to the support and the other end connecting to the latch, the latch and the support can move relatively toward each other.

A part of the latch extends out of the housing to engage with the keyboard. When an external force causes the latch to withdraw into the housing, the latch will make the first saw-toothed elastic strip deform and will move toward the support. Then, the latch detaches from the keyboard, and the first saw-toothed elastic strip provides a recovering force forcing a part of the latch to spring out of the housing.

### BRIEF DESCRIPTION OF THE DRAWINGS

FIG. 1 shows a schematic diagram of the latch device and the portable electronic apparatus.

FIG. 2a shows a schematic diagram of an embodiment of the latch device of the present invention.

FIG. 2b shows a schematic diagram of another embodiment of the latch device of the present invention.

FIG. 2c shows a schematic diagram of another embodiment of the latch device of the present invention.

FIG. 3a shows a top view of an embodiment when the latch device engages with the keyboard.

FIG. 3b shows a top view of an embodiment when the latch device releases the keyboard.

FIG. 4a shows a top view of the latch device in FIG. 2.

FIG. 4b shows a top view of another embodiment of the latch device of the present invention.

FIG. 4c shows a top view of another embodiment of the latch device of the present invention.

FIG. 5a shows a top view of another embodiment of the latch device of the present invention.

FIG. 5b shows a top view of another embodiment of the latch device of the present invention.

FIG. 6a shows a top view of an embodiment of the latch device in FIG. 5a engaging with the keyboard.

FIG. 6b shows a top view of an embodiment of the latch device in FIG. 5a releasing the keyboard.

FIG. 7 shows a top view of another embodiment of the latch device of the present invention.

### DETAILED DESCRIPTION OF THE INVENTION

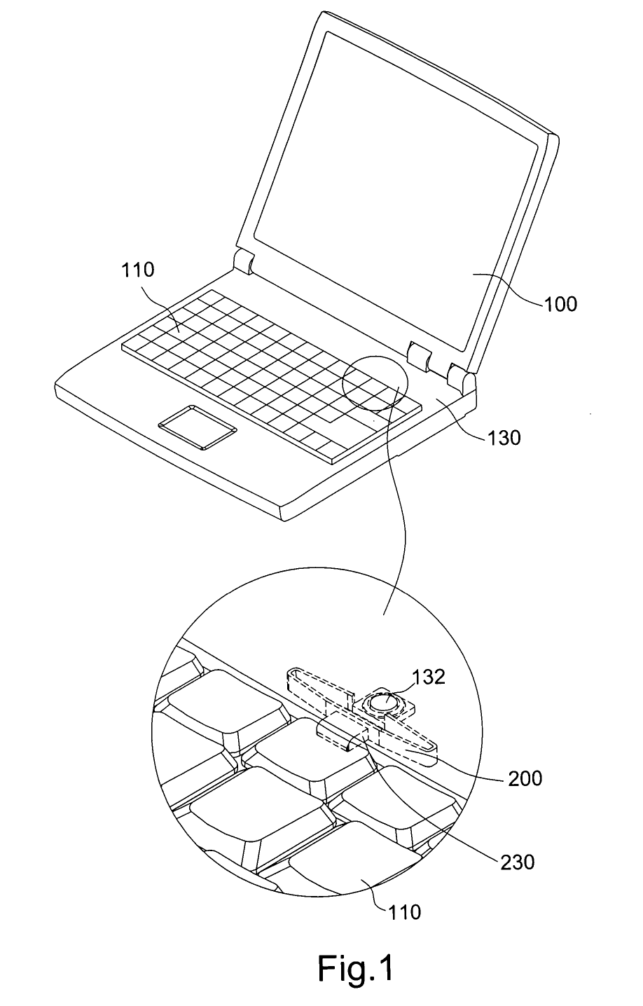

The present invention provides a latch device 200 for use with a portable electronic apparatus 100. FIG. 1 shows the latch device 200 of the present invention cooperating with the portable electronic apparatus 100. The latch device 200 engages wit the predetermined device within the housing 130 to prevent detachment of the predetermined device from the housing 130. In FIG. 1, the predetermined device of the embodiment is a keyboard 110; however, it can also be a digital input pad, a speaker or other devices that cooperate with the portable electronic apparatus 100.

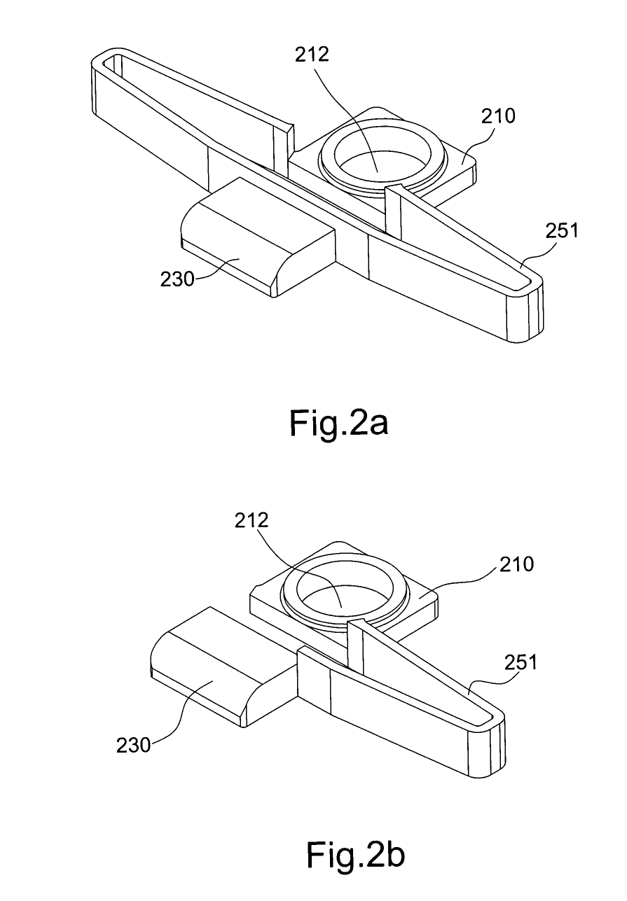

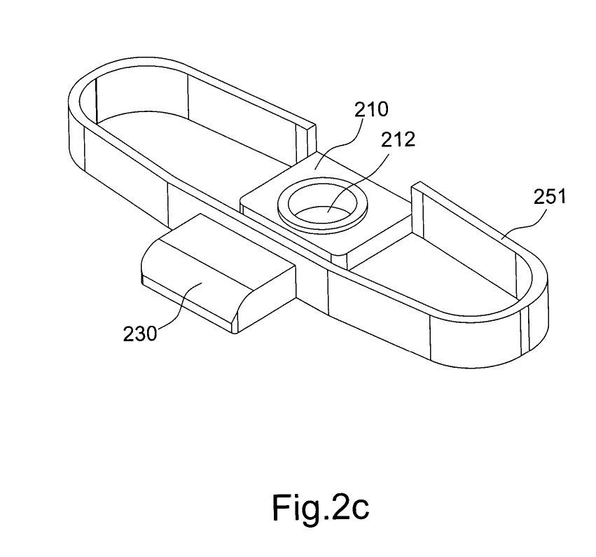

As the embodiment shows in FIG. 1 and FIG. 2a, the latch device 200 includes a support 210, a latch 230 and a saw-toothed elastic strip 251. The support 210 dovetails with the housing 130. As shown in FIG. 1 and FIG. 2a, the support 210 further includes a hole 212. A salient 132 of the housing 130 passes through the hole 212 to fix the support 210. However, in other embodiments, the support 210 can also be glued to, bolted to, embedded in the housing 130, or connected to it by other methods that provide similar functions.

As shown in FIG. 1, the latch 230 is used to engage with the keyboard 110. As shown in FIG. 2a, the wedge-shaped cross-section of latch 230 makes it easier for the keyboard 110 to slide along the inclined plane of the wedge engage with the latch 230. However, in other embodiments, the cross-sectional plane of the latch 230 can be in other shapes that provide similar functions.

As shown in FIG. 2a, one end of the first saw-toothed elastic strip 251 connects to the support and the other connects to the latch 230. Through the first saw-toothed elastic strip 251, the latch 230 and the support 210 can move relatively toward each other. In the embodiment shown in FIG. 2a, there is a pair of the first saw-toothed elastic strips 251 to make the latch 230 move toward the support 210 in a more balanced way. However, in other embodiments, such as the one shown in FIG. 2b, there can be only one first saw-toothed elastic strip 251 connecting to the support 210 and the latch 230.

In the embodiment shown in FIG. 2a, the first saw-toothed elastic strip 251 is between support 210 and the latch 230. However, the support 210 can also be under the first saw-toothed elastic strip 251, as another embodiment of in FIG. 2c shows.

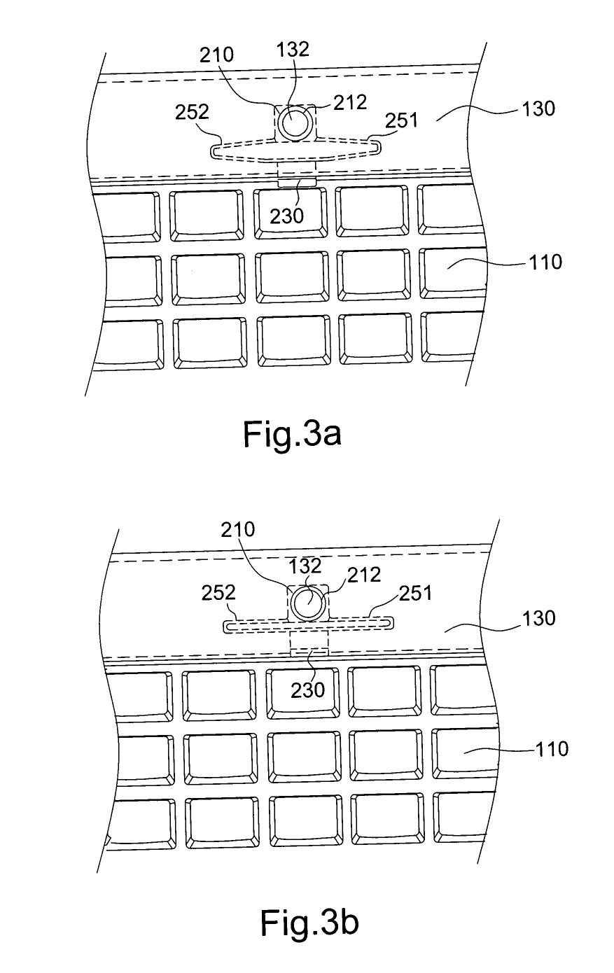

FIG. 3a shows a top view of an embodiment when the latch device 200 engaging with the keyboard 110. As shown in FIG. 3a, a part of the latch 200 extends out of the housing 130, and the outer part of the latch 230 engages with the keyboard 110. In this embodiment, the outer part of the latch 230 engages with the upper part of the keyboard 110. However, the outer part of the latch 230 can also engage with a fillister on the sidewall of the keyboard 110 in other embodiments (not illustrated). FIG. 3b shows a top view of an embodiment when the latch device releasing the keyboard. As shown in FIG. 3b, when an external force forces the latch 230 to withdraw into the housing 130, the latch 230 forces the first saw-toothed elastic strip 25 1 to deform and move toward the support 210. Then the latch 230 releases the keyboard 110 so it detaches from the housing 130. Because the first saw-toothed strip 251 has deformed, it provides a recovering force for the latch 230. When the force on the latch 230 is gone, the recovering force of the first saw-toothed elastic strip 251 makes a part of the latch 230 spring out, with the support 210 as a fulcrum.

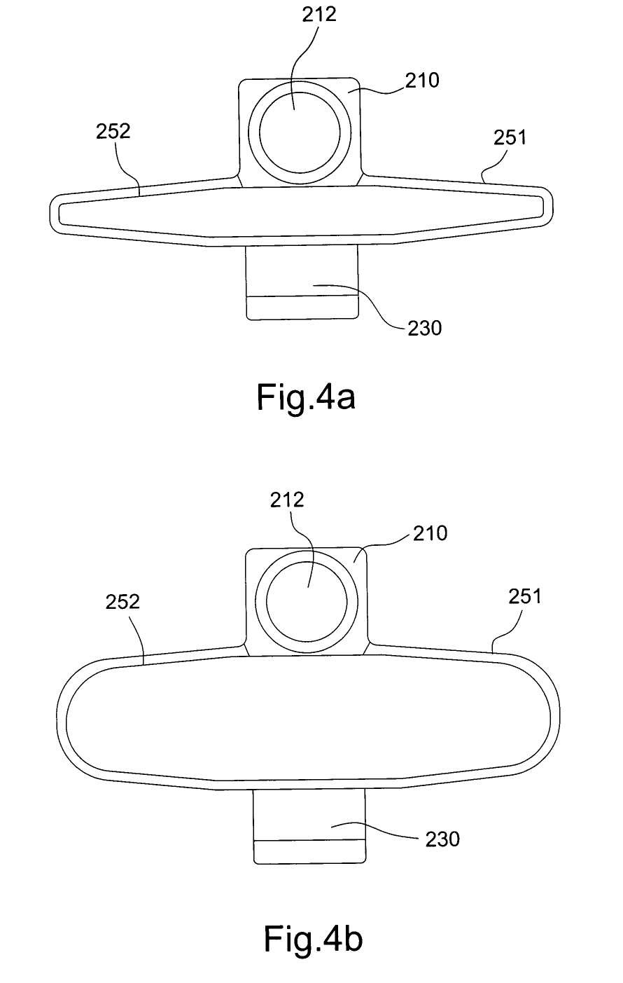

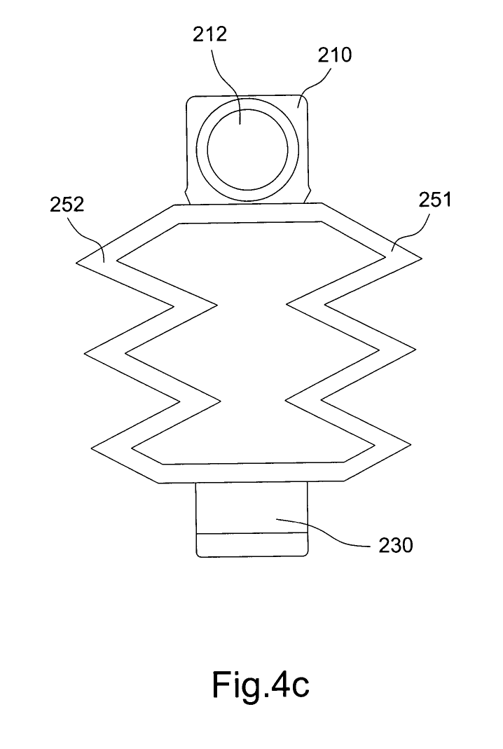

FIG. 4a shows a top view of the latch device 200 in FIG. 2. As FIG. 4a shows, the first saw-toothed elastic strip 251 includes a V-shaped strip. In another embodiment shown in FIG. 4b, the first saw-toothed elastic strip 251 includes a U-shaped strip. Besides, the first saw-toothed elastic strip 251 may consist of a plurality of strips like the embodiment shown in FIG. 4c. In FIG. 4c, the first saw-toothed elastic strip 251 consists of a plurality of V-shaped strips. It should be noticed that the shapes of first saw-toothed elastic strips 251 are not restricted by foregoing embodiments; the strips may be in other shapes or structures that produces elastic force.

As shown in FIG. 4a, the latch device 200 further comprises a second saw-toothed elastic strip 252. The two ends of the second saw-toothed elastic strip 252 connect respectively to the two corresponding ends of the first saw-toothed elastic strip 251. In other words, the first saw-toothed elastic strip 251 and the second saw-toothed elastic strip 252 together form a close loop. The close loop structure provides the latch device 200 of the present invention with a more balanced and stable force state. In this embodiment, the second saw-toothed elastic strip 252 has a shape symmetrical to the first saw-toothed elastic strip 251, and connects to the first saw-toothed elastic strip 251 symmetrically. However, in other embodiments, the second saw-toothed elastic strip 252 can be in other shapes providing similar functions; it is not necessary to be in the same shape as the first saw-toothed elastic strip 251 is. For example, if the first saw-toothed elastic strip 251 is a V-shaped strip, the second saw-toothed elastic strip 252 can be a V-shaped strip or a U-shaped strip.

In the aforementioned embodiments of the present invention, the latch device 200 is formed integrally. The method of forming can be injection molding, casting, modeling, press molding or other methods providing similar results.

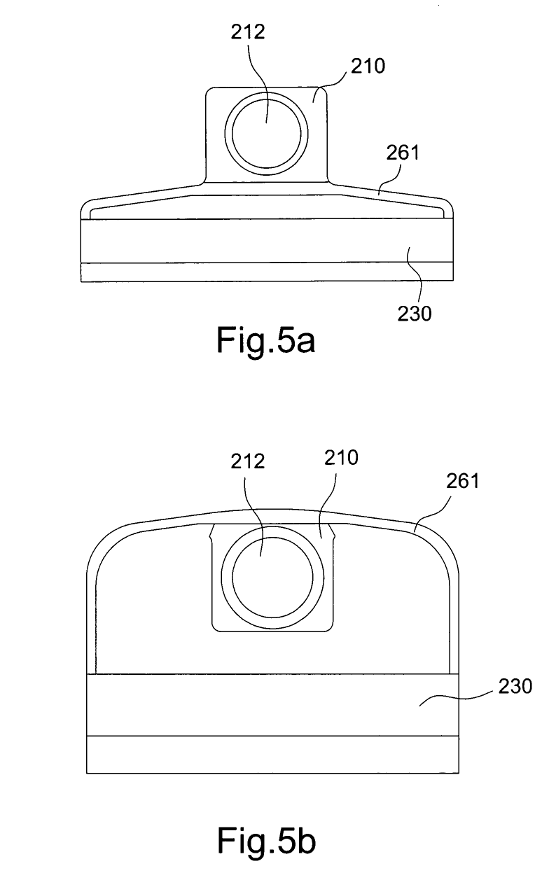

FIG. 5a is a top view of another embodiment of the latch device 200 of the present invention. In this embodiment, a smooth first arc-shaped elastic strip 261 substitutes for the first saw-toothed elastic strip 251. However, the first arc-shaped elastic strip 261 can be an arc-shaped elastic strip with a bending angle, a symmetric arc-shaped elastic strip or an asymmetric arc-shaped elastic strip in other embodiments.

As shown in FIG. 5a, the two ends of the first arc-shaped elastic strip 261 connect to the latch 230. The support 210 connects to the middle part of the first arc-shaped elastic strip 261. In this embodiment, the first arc-shaped elastic strip 261 is between support 210 and latch 230. However, the support 210 can be under the first arc-shaped elastic strip 261 in another embodiment of as shown in FIG. 5a.

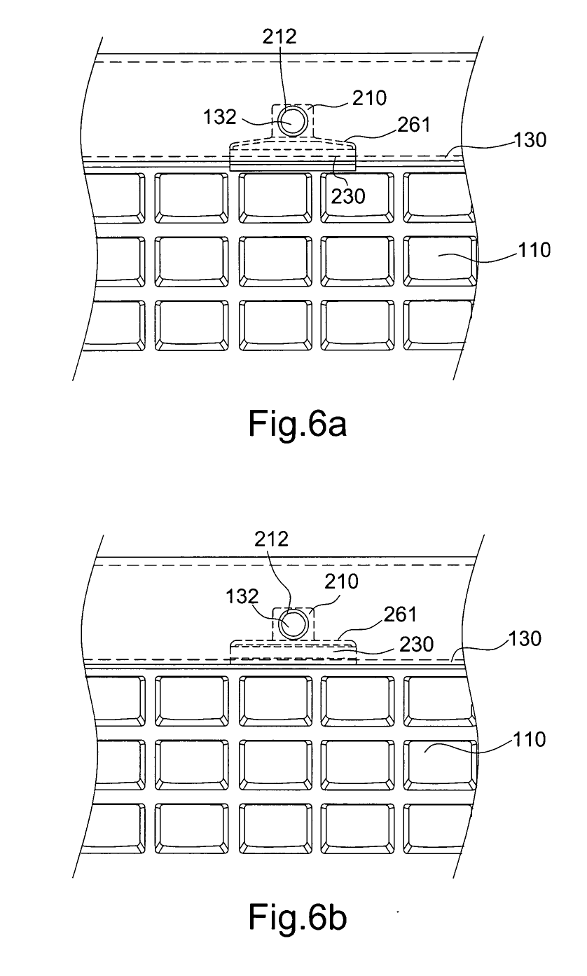

FIG. 6a is a top view of the latch device 200 in FIG. 5a engaging with the keyboard 110 in the embodiment. As shown in FIG. 6a, a part of the latch 230 extends out of the housing 130, and connects to the keyboard 110. FIG. 6b is a top view of an embodiment when the latch 230 in FIG. 5a releases the keyboard 110. As shown in FIG. 6b, when an external force is applied, the latch 230 forces the first arc-shaped elastic strip 261 to deform and move toward the support 210. The latch 230 releases the keyboard 110, and the keyboard 110 detaches from the housing 130. At the same time, the first arc-shaped strip 261 provides a recovering force for the latch 230 due to the deformation of the strip. When the force on the latch 230 is gone, the recovering force of first arc-shaped elastic strip 261 makes a part of the latch 230 spring out, with the support 210 as a fulcrum.

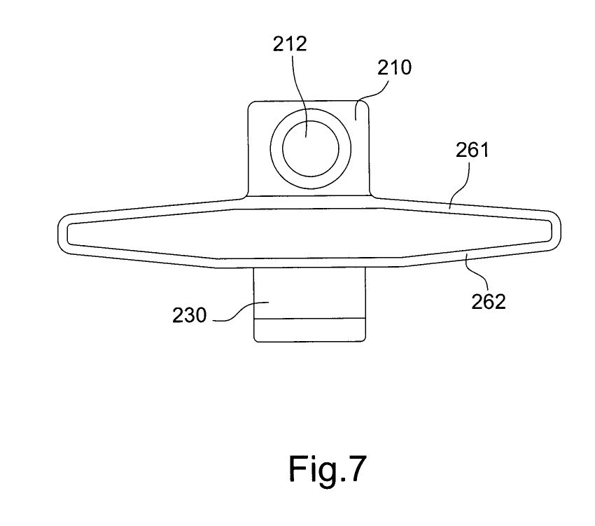

As shown in FIG. 7, the latch device 200 further comprises a second arc-shaped elastic strip 262. The two ends of the second arc-shaped elastic strip 262 connect respectively to the two corresponding ends of the first arc-shaped elastic strip 261. In other words, the first arc-shaped elastic strip 261 and the second arc-shaped elastic strip 262 together form a close loop. The close loop structure provides the latch device 200 of the present invention with a more balanced and stable force state. In this embodiment, the second arc-shaped elastic strip 262 has a shape symmetrical to the first arc-shaped elastic strip 261, and connects to the first arc-shaped elastic strip 261 symmetrically. However, the second arc-shaped elastic strip 262 can be in other shapes providing similar functions; it is not necessary to be in the same shape as the first arc-shaped elastic strip 261 is in other embodiments. For example, if the first arc-shaped elastic strip 261 is a smooth elastic strip, the second arc-shaped elastic strip 262 can be a smooth elastic strip or a bending elastic strip.

While the invention has been described in connection with what is presently considered to be the most practical and preferred embodiments, it is to be understood that the invention is not to be limited to the discovered embodiments. The invention is intended to cover various modifications and equivalent arrangement included within the spirit and scope of the appended claims.

1 A latch device for use with a portable electrical apparatus, the portable electrical apparatus having a predetermined device and a housing, the latch device preventing separation of the predetermined device from the housing, the latch device comprising:
a support connecting to the housing;
a latch for latching the predetermined device; and
a first saw-toothed elastic strip, one end of the first saw-toothed elastic strip connecting to the support and another end connecting to the latch for allowing the latch to move relative to the support.

2 The latch device of claim 1, wherein the predetermined device includes a keyboard.

3 The latch device of claim 1, wherein the latch latches the predetermined device when a part of the latch sticks out from the housing, the latch deforms the first saw-toothed elastic strip when an external force forces the latch to separate from the predetermined device, and the first saw-toothed elastic strip provides a recovering force forcing a part of the latch to spring out of the housing.

4 The latch device of claim 1, further comprising a second saw-toothed elastic strip, both ends of the second saw-toothed elastic strip respectively connecting to two corresponding ends of the first saw-toothed elastic strip, the first saw-toothed elastic strip and the second saw-toothed elastic strip together forming a close loop.

5 The latch device of claim 1, wherein the first saw-toothed elastic strip includes a V-shaped strip.

6 The latch device of claim 1, wherein the first saw-toothed elastic strip includes a U-shaped strip.

7 The latch device of claim 1, wherein the latch device is formed integrally.

8 The latch device of claim 1, wherein the first saw-toothed elastic strip is disposed between the support and the latch.

9 The latch device of claim 1, wherein the support connects to the housing dovetailedly.

10 A portable electrical device, comprising the latch device of claim 1,2,3,4,5,6,7,8 or 9.

11 A latch device for use with a portable electrical apparatus, the portable electrical apparatus having a predetermined device and a housing, the latch device preventing separation of the predetermined device from the housing, the latch device comprising:
a support connecting to the housing;
a latch for latching the predetermined device; and
a first arc-shaped elastic strip for allowing the latch to move relative to the support, both ends of the first arc-shaped elastic strip respectively connecting to the latch, the support connecting to the first arc-shaped elastic strip at a location between the two ends of the first arc-shaped elastic strip.

12 The latch device of claim 11, wherein the predetermined device includes a keyboard.

13 The latch device of claim 11, wherein the latch latches the predetermined device when a part of the latch sticks out from the housing, the latch deforms the first arc-shaped elastic strip when an external force forces the latch to separate from the predetermined device, and the first arc-shaped elastic strip provides a recovering force forcing a part of the latch to spring out the housing.

14 The latch device of claim 11, further comprising a second arc-shaped elastic strip, both ends of the second arc-shaped elastic strip respectively connecting to two corresponding ends of the first arc-shaped elastic strip, the first arc-shaped elastic strip and the second arc-shaped elastic strip together forming a close loop, the latch connecting to the second arc-shaped elastic strip between the two ends of the second arc-shaped elastic strip.

15 The latch device of claim 13, wherein the latch device is formed integrally.

16 The latch device of claim 13, wherein the first arc-shaped elastic strip is disposed between the support and the latch.

17 The latch device of claim 13, wherein the support connects to the housing dovetailedly.

18 A portable electrical device, comprising the latch device of claim 13,14,15,16 or 17.
